(19) United States
(12) Patent Application Publication
(10) Pub. No.: US 2023/0036281 A1
(43) Pub. Date: Feb. 2, 2023

(54) BATTERY AND DISPLAY PANEL

(71) Applicant: BOE TECHNOLOGY GROUP CO., LTD., Beijing (CN)

(72) Inventors: Yue CUI, Beijing (CN); Sitong CHEN, Beijing (CN); Yuehan WEI, Beijing (CN); Xiaolin LIU, Beijing (CN)

(21) Appl. No.: 17/789,190

(22) PCT Filed: Sep. 3, 2021
(86) PCT No.: PCT/CN2021/116409

§ 371 Date: Jun. 25, 2022

(30) Foreign Application Priority Data
Oct. 30, 2020 (CN) 202011193806.9

(51) Int. Cl. H01M 50/112; H01M 50/534; H01M 50/538; H01M 50/55; H01M 50/562; H01M 50/119; H01M 50/121; H01M 50/129; H01M 50/174; H01M 50/133; H01M 50/136

(52) U.S. Cl. CPC H01M 50/112; H01M 50/534; H01M 50/538; H01M 50/55; H01M 50/562; H01M 50/119; H01M 50/121; H01M 50/129; H01M 50/174; H01M 50/133; H01M 50/136; H01M 2220/30

(57) ABSTRACT

Embodiments of the present disclosure provide a battery, which includes a plurality of energy storage units; and a connecting portion that connects the plurality of energy storage units together in parallel, where the connecting portion is made of a flexible material. The embodiments of the present disclosure further provides a display panel, which includes the above battery and a flexible display module, where the battery is provides on a back side of the flexible display module, the battery is electrically connected with the flexible display module for providing power to the flexible display module.

### TECHNICAL FIELD

Embodiments of the present disclosure relates to the field of display technology, and particularly relates to a battery and a display panel.

### BACKGROUND

In recent years, with the application of flexible visualization devices, a bendability characteristic has become a trend in the display industry, which has led to an increasing demand for flexibility of power supply devices. In the power supply devices, lithium battery is one of mature systems. A traditional lithium battery has excellent energy density, but the material inside the battery does not have good tensile property, so that the development of the lithium battery in the flexible application field is limited.

### SUMMARY

Embodiments of the disclosure provides a battery and a display panel.

In a first aspect, an embodiment of the present disclosure provides a battery, including a plurality of energy storage units; and a connecting portion that connects the plurality of energy storage units together in parallel, where the connecting portion is made of a flexible material.

In some implementations, the connecting portion includes a first layer, a second layer and a third layer which are sequentially stacked, the first layer and the third layer being made of a flexible insulating adhesive material, and the second layer being made of a metal material.

In some implementations, a total thickness of the first layer, the second layer and the third layer is in a range from 10 μm to 40 μm.

In some implementations, each energy storage unit includes a positive plate, a diaphragm and a negative plate, which are sequentially stacked and wound to form a roll core, the positive plate extends out of a region, in which the positive plate, the diaphragm and the negative plate are sequentially stacked, to form a positive tab, and the negative plate extends out of the region, in which the positive plate, the diaphragm and the negative plate are sequentially stacked, to form a negative tab;

the second layer includes a first sublayer and a second sublayer, and the first sublayer and the second sublayer are arranged in a same layer and are spaced apart from each other;

the positive tab is electrically connected with the first sublayer, and the negative tab is electrically connected with the second sublayer;

the first sublayer extends out of a region, in which the first layer, the second layer and the third layer are stacked, to form a positive pole of the battery, and the second sublayer extends out of the region, in which the first layer, the second layer and the third layer are stacked, to form a negative pole of the battery.

In some implementations, a material of the first sublayer includes aluminum, and a material of the second sublayer includes copper.

In some implementations, the plurality of energy storage units are disposed on a side of the first layer away from the second layer, the plurality of energy storage units being spaced apart from each other.

In some implementations, the plurality of energy storage units are parallel to each other and equally spaced apart from each other.

In some implementations, the plurality of energy storage units includes a plurality of first energy storage units and a plurality of second energy storage units, the plurality of first energy storage units are arranged on a side of the first layer away from the second layer, and the plurality of first energy storage units are spaced apart from each other;

the plurality of second energy storage units are arranged on a side of the third layer away from the second layer, and the plurality of second energy storage units are spaced apart from each other.

In some implementations, the plurality of first energy storage units are parallel to each other and equally spaced apart from each other, and the plurality of second energy storage units are parallel to each other and are equally spaced apart from each other;

orthographic projections of the first energy storage units on the first layer are coincident with orthographic projections of the second energy storage units on the first layer.

In some implementations, the battery further includes: a packaging portion, which encases the plurality of energy storage units and the connecting portion.

In some implementations, the packaging portion includes a heat sealing layer, a metal layer and a protective layer, which are sequentially stacked, the heat sealing layer being in contact with the plurality of energy storage units and the connecting portion.

In some implementations, a material of the heat sealing layer includes a polypropylene (PP) material or cast polypropylene (CPP) material, a material of the metal layer includes aluminum or stainless steel, and a material of the protective layer includes nylon.

In some implementations, a total thickness of the heat sealing layer, the metal layer and the protective layer is in a range from 50 μm to 200 μm.

In some implementations, a shape of an orthographic projection of each energy storage unit on the first layer comprises any one of a rectangle, a rounded rectangle, an ellipse, a hexagon, or a rhombus.

In some implementations, volume energy densities of the energy storage units are the same, and volumes of the energy storage units are the same;

a capacity C of the battery meets the following equation: C=NρSh, wherein N is the number of the energy storage units, ρ is the volume energy density of the energy storage unit, S is an area of the orthographic projection of the energy storage unit on the first layer; h is a height of the energy storage unit in a direction away from the first layer.

In some implementations, volume energy densities of the first energy storage units are the same, and volumes of the first energy storage units are the same, volume energy densities of the second energy storage units are the same, and volumes of the second energy storage units are the same;

the volume energy density of each first energy storage unit is the same as that of each second energy storage unit, and the volume of each first energy storage unit is the same as that of each second energy storage unit;

the capacity C of the battery meets the equation: C=N1ρS1h1+N2ρS2h2, wherein N1 is the number of the first energy storage units, N2 is the number of the second energy storage units, ρ is the volume energy density of the first energy storage unit, S1 is an area of the orthographic projection of the first energy storage unit on the first layer, h1 is a height of the first energy storage unit in a direction away from the first layer, S2 is an area of the orthographic projection of the second energy storage unit on the third layer, and h2 is a height of the second energy storage unit in a direction away from the third layer.

In a second aspect, an embodiment of the present disclosure further provides a display panel, which includes the above battery and a flexible display module, where the battery is disposed on a back side of the flexible display module, and the battery is electrically connected with the flexible display module for supplying power to the flexible display module.

### DRAWINGS

The accompanying drawings are used to provide a further understanding of the embodiments of the present disclosure, constitute a part of the description, and are used to explain the present disclosure together with the embodiments of the present disclosure, and do not constitute a limitation of the present disclosure. The above and other features and advantages will become more apparent to those skilled in the art by describing the detailed example embodiments with reference to the accompanying drawings.

FIG. 1 is a schematic structural side view of a battery according to an embodiment of the present disclosure.

FIG. 2 is a schematic structural cross-sectional view of a connecting portion of a battery according to an embodiment of the present disclosure.

FIG. 3 is a schematic structural diagram of an energy storage unit of a battery according to an embodiment of the present disclosure.

FIG. 4 is a schematic structural top view of a battery according to an embodiment of the present disclosure.

FIG. 5 is a schematic structural cross-sectional view of a packaging portion of a battery according to an embodiment of the present disclosure.

FIG. 6 is a schematic diagram illustrating a shape of an orthographic projection of the energy storage unit on a first layer according to an embodiment of the present disclosure.

FIG. 7 is a diagram illustrating dimensions of structures in a battery according to an embodiment of the present disclosure.

FIG. 8 is a schematic diagram illustrating a shape and dimensions of an orthographic projection of the energy storage unit on a first layer according to an embodiment of the present disclosure.

FIG. 9 is a schematic structural side view of a battery according to another embodiment of the present disclosure.

FIG. 10 is a diagram illustrating dimensions of structures in a battery according to another embodiment of the present disclosure.

FIG. 11 is a schematic diagram illustrating a shape and dimensions of an orthographic projection of the energy storage unit on a first layer according to another embodiment of the present disclosure.

FIG. 12 is a schematic structural diagram of a display panel according to an embodiment of the disclosure.

### THE REFERENCE NUMBERS ARE AS FOLLOWS:

1. energy storage unit; 11. positive tab; 12. negative tab; 2. connecting portion; 21. first layer; 22. second layer; 221. first sublayer; 222. second sublayer; 23. third layer; 3. positive pole; 4. negative pole; 5. packaging portion; 51. heat sealing layer; 52. metal layer; 53. protective layer; 101. first energy storage unit; 102. second energy storage unit; 6. battery; 7. flexible display module.

### DETAILED DESCRIPTION

In order to enable those skilled in the art to better understand the technical solutions of the embodiments of the present disclosure, a battery and a display panel provided in the embodiments of the present disclosure are described in further detail below with reference to the accompanying drawings.

The embodiments of the present disclosure will be described more fully hereinafter with reference to the accompanying drawings, but the embodiments shown may be embodied in different forms and should not be construed as limited to the embodiments set forth herein. Rather, these embodiments are provided so that the present disclosure will be thorough and complete, and will fully convey the scope of the disclosure to those skilled in the art.

The embodiments of the present disclosure are not limited to the embodiments shown in the drawings, but include modifications of configurations formed based on a manufacturing process. Thus, regions illustrated in the drawings have schematic properties, and shapes of the regions shown in the drawings illustrate specific shapes of the regions, but are not intended to be limiting.

How to solve the problem of power shortage of a wearable equipment currently becomes a research focus in the field of flexible power supply. At present, it is proposed to insert a flexible battery into a strap of a smart watch to provide additional power for the smart watch, so that the wearable equipment can operate longer. However, the above solution can not truly realize an advantage of full flexibility of the flexible display module.

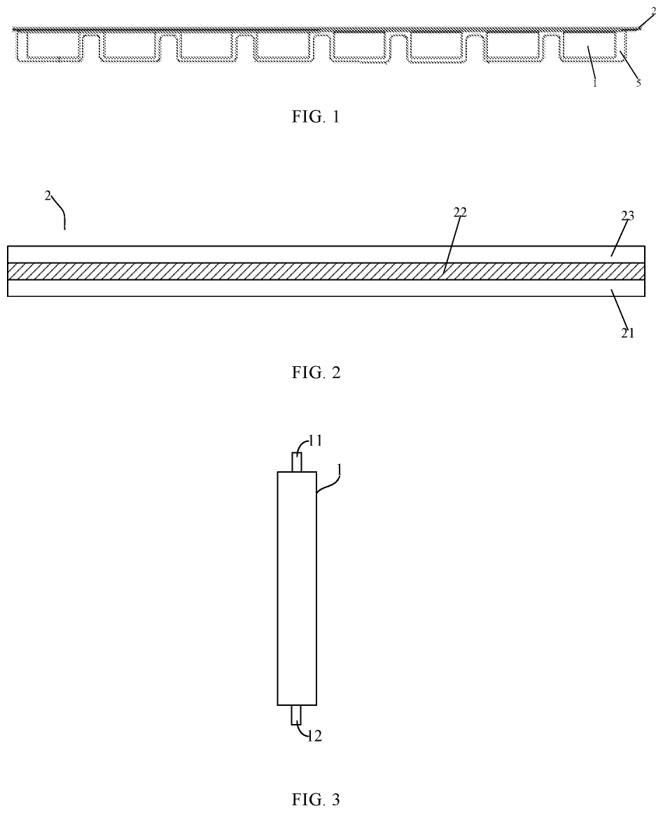

In order to solve the problem that a flexible power supply cannot be implemented at present, an embodiment of the present disclosure provides a battery, as shown in FIG. 1, which includes: a plurality of energy storage units 1; a connecting portion 2 that connects the plurality of energy storage units 1 together in parallel, where the connecting portion 2 is made of a flexible material.

In the battery, the plurality of energy storage unit 1 are connected together in parallel through the connecting portion 2 made of the flexible material, so that not only the capacity of the battery can be increased, but also a flexible bending of the battery can be realized, and thus the battery not only can provide a power supply with great capacity for a flexible equipment, but also can bend along with the flexible equipment, therefore, the full flexibility of the flexible equipment can be better realized.

In some implementations, as shown in FIG. 2, the connecting portion 2 includes a first layer 21, a second layer 22 and a third layer 23 which are sequentially stacked, where the first layer 21 and the third layer 23 are made of a flexible insulating adhesive material, and the second layer 22 is made of a metal material. The first layer 21 and the third layer 23 are made of a polymer compound, for example, a resin material, such as polyimide, polyurethane, or the like. The first layer 21 and the third layer 23 encase the second layer 22. The connecting portion 2 is formed by applying an adhesive material or evaporating an adhesive material on the third layer 23, and sputtering a metal material on the adhesive material. The polymer compound can improve a mechanical bendability performance of the connecting portion 2, so that the connecting portion 2 has a certain flexible bendability performance.

In some implementations, a total thickness of the first layer 21, the second layer 22 and the third layer 23 is in a range from 10 nm to 40 nm. With such thickness and the first layer 21 and the second layer 22 being made of flexible insulating adhesive material, the connecting portion 2 has good flexible bendability performance.

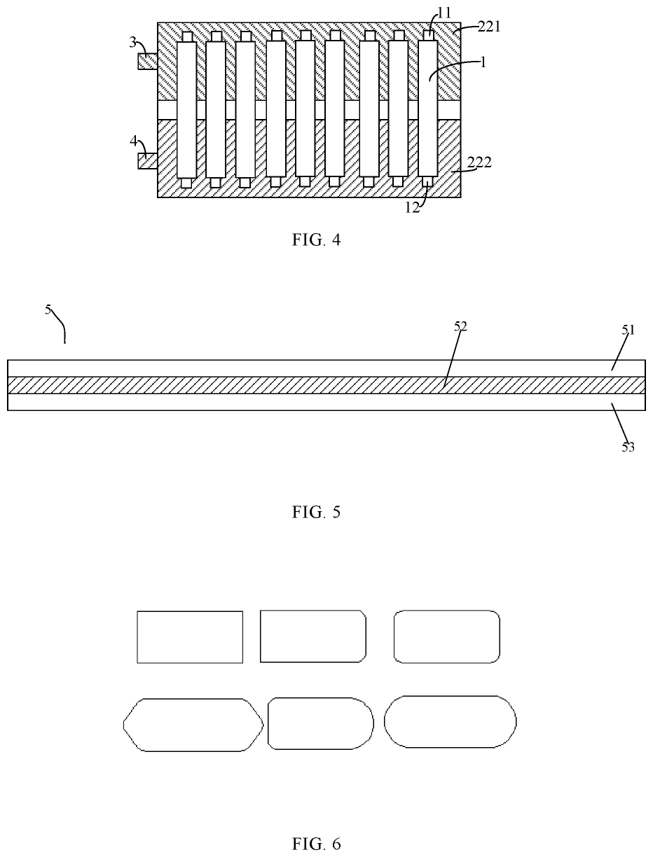

In some implementations, as shown in FIG. 3, the energy storage unit 1 includes a positive plate, a diaphragm and a negative plate. The positive plate, the diaphragm and the negative plate are sequentially stacked and wound to form a roll core. The positive plate extends out of a region, in which the positive plate, the diaphragm and the negative plate are sequentially stacked, to form a positive tab 11, and the negative plate extends out of the region, in which the positive plate, the diaphragm and the negative plate are sequentially stacked, to form a negative tab 12. Certainly, the positive tab 11 may be welded to the positive plate, and the negative tab 12 may be welded to the negative plate. As shown in FIG. 4, the second layer 22 includes a first sublayer 221 and a second sublayer 222, and the first sublayer 221 and the second sublayer 222 are disposed in a same layer and spaced apart from each other. The positive tab 11 is electrically connected to first sublayer 221, and the negative tab 12 is electrically connected to the second sublayer 222. The first sublayer 221 extends out of a region, in which the first layer 21, the second layer 22, and the third layer 23 are stacked, to form a positive pole 3 of the battery, and the second sublayer 222 extends out of the region, in which the first layer 21, the second layer 22, and the third layer 23 are stacked, to form a negative pole 4 of the battery. The positive tab 11 of each energy storage unit 1 is electrically connected with the first sublayer 221, and the negative tab 12 of each energy storage unit 1 is electrically connected with the second sublayer 222, so that the energy storage units 1 are connected in parallel, where a total capacity of the energy storage units 1 connected in parallel is a sum of capacities of the energy storage units 1, so that the capacity of the battery can be greatly increased.

In some implementations, the energy storage unit 1 may be a lithium ion battery, and a positive plate of the lithium ion battery is made of a lithium-containing metal compound material of a transition group, a negative plate of the lithium ion battery is made of a carbon material, and the diaphragm of the lithium ion battery is made of PP or PE material. In addition, in a case where the energy storage unit 1 is a lithium ion battery, an organic electrolyte containing a lithium salt may be further included in the energy storage unit 1. The lithium ion battery may be of a roll structure in which the positive plate, the diaphragm and the negative plate are sequentially stacked and wound to form a roll core, or of a laminated structure in which the positive plate, the diaphragm and the negative plate are sequentially stacked. In addition, the energy storage unit 1 may also be a polymer battery. A structure of the polymer battery is mature, and is not described in detail herein.

In some implementations, a material of the first sublayer 221 includes aluminum, and a material of the second sublayer 222 includes copper.

In some implementations, the plurality of energy storage units 1 are arranged on a side of the first layer 21 away from the second layer 22, the plurality of energy storage units 1 being spaced apart from each other. The positive tab 11 of each energy storage unit 1 is electrically connected to the first sublayer 221 through a pad formed on a surface of the first sublayer 221 and exposed through an opening formed in the first layer 21, and the negative tab 12 of each energy storage unit 1 is electrically connected to the second sublayer 222 through a pad formed on a surface of the second sublayer 222 and exposed through an opening formed in the first layer 21.

In some implementations, the plurality of energy storage units 1 are parallel to each other, and equally spaced apart from each other, i.e., the energy storage units 1 are positioned at equal intervals. The capacities of the energy storage units 1 may be equal or different. Volumes of the energy storage units 1 may be equal or different. With such arrangement, positions at the intervals between the energy storage units 1 of the battery can achieve a same flexible bending degree.

In some implementations, the battery further includes a packaging portion 5, and the packaging portion 5 encases the plurality of energy storage units 1 and the connecting portion 2. The packaging portion 5 can well protect the energy storage units 1 and the connecting portion 2 from moisture invasion, and scratch or damage.

In some implementations, as shown in FIG. 5, the packaging portion 5 includes a heat sealing layer 51, a metal layer 52, and a protective layer 53 which are sequentially stacked. The heat sealing layer 51 is in contact with the energy storage units 1 and the connecting portion 2. Heat sealing layers 51 of the packaging portion 5 located at upper and lower sides of the connecting portion 2 can be heat-sealed, so that all the energy storage units 1 and the connecting portion 2 are wrapped thereinside, and the energy storage units 1 and the connecting portion 2 are well sealed and packaged.

In some implementations, a material of the heat sealing layer 51 includes PP or CPP material, a material of the metal layer 52 includes aluminum, and a material of the protective layer 53 includes nylon. Namely, the packaging portion 5 adopts an aluminum plastic film. The aluminum has a good effect of isolating moisture. The protective layer 53 is made of a polymer film material and can prevent appearance change and surface scratch of the packaging material from occurring. The metal layer 52 may be made of stainless steel.

In some implementations, a total thickness of the heat sealing layer 51, the metal layer 52, and the protective layer 53 ranges from 50 μm to 200 μm. The packaging portion 5 with such thickness can well package the energy storage units 1 and the connecting portion 2, and an overall flexible bending performance of the battery cannot be influenced, so that the connecting portion 2 packaged by the packaging portion 5 still keeps good flexibility performance.

In some implementations, as shown in FIG. 6, a shape of the orthographic projection of each energy storage unit 1 on the first layer 21 includes any one of a rectangle, a rounded rectangle, an ellipse, a hexagon, or a rhombus. Certainly, the shape of the orthographic projection of each energy storage unit 1 on the first layer 21 may be any other shape.

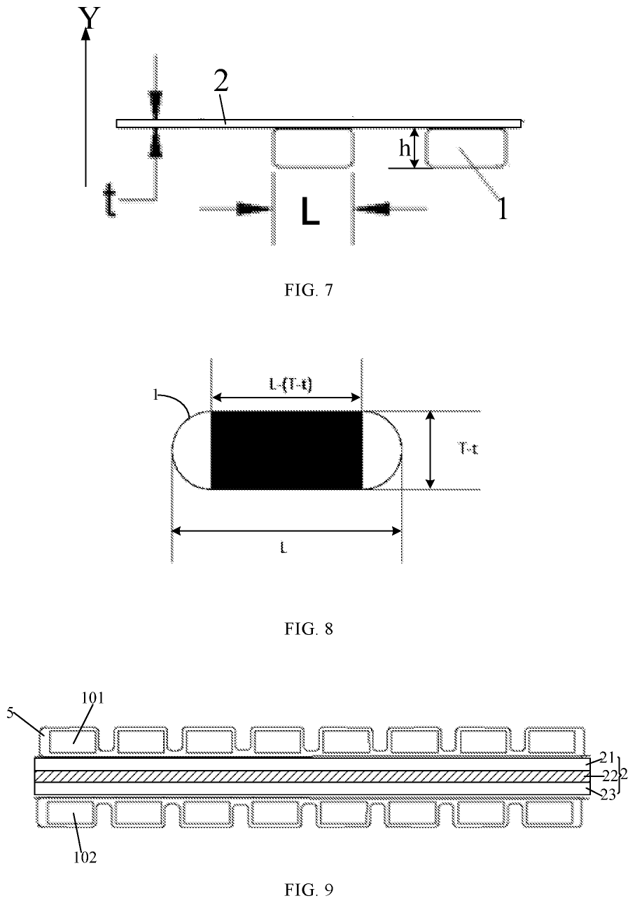

In some implementations, as shown in FIG. 7, volume energy densities of the energy storage units 1 are the same, and volumes of the energy storage units 1 are the same, the capacity C of the battery is equal to NρSh, that is, C=NρSh, where N is the number of the energy storage units 1, ρ is the volume energy density of the energy storage unit 1, S is an area of the orthographic projection of the energy storage unit 1 on the first layer 21, and h is a height of the energy storage unit 1 in a direction away from the first layer 21.

In some implementations, as shown in FIG. 8, the shape of the orthographic projection of each energy storage unit 1 on the first layer 21 is a rectangle plus two semicircles, where the rectangle is located between the two semicircles, and the two semicircles with a same diameter are located at two opposite ends of the rectangle, respectively, and are symmetrically arranged with respect to the rectangle. For the area of the orthographic projection of the energy storage unit 1 on the first layer 21, a total area of the two semicircles is ¼π(T−t)²; an area of the rectangle is (L−T+t)*(T−t); the area S1 of the orthographic projection of each energy storage unit 1 on the first layer 21 meets the following equation: S1=¼π(T−t)²+(L−T+t)*(T−t). Then the capacity C1 of each energy storage unit 1 meets a equation of: C1=ρ[¼π(T−t)²+(L−T+t)*(T−t)]h, and the capacity C of the battery meets a equation of: C=NC1=Nρ[¼π(T−t)²+(L−T+t)*(T−t)]h. Here, a direction perpendicular to the first layer 21 is referred to as a first direction Y. T is a total thickness of the battery in the first direction Y, t is a thickness of the connecting portion 2 in the first direction Y, h is the height of the energy storage unit 1 in the first direction Y, L is a total length of a pattern of the orthographic projection of the energy storage unit 1 on the first layer 21 in a direction in which the rectangular and the semicirculars are arranged.

It should be noted that, in some implementations, the energy storage units 1 are sequentially arranged in a straight line. The energy storage units 1 arranged on a single side of the connecting portion 2 may also be arranged in an array, as long as the positive tab 11 and the negative tab 12 of each energy storage unit 1 can be connected to the first sublayer 221 and the second sublayer 222, respectively. Therefore, more energy storage units can be integrated into the battery, and the capacity of the battery can be further increased.

An embodiment of the present disclosure further provides a battery, which is different from that in the above embodiment in that, as shown in FIG. 9, the plurality of energy storage units include a plurality of first energy storage units 101 and a plurality of second energy storage units 102, the plurality of first energy storage units 101 are disposed on a side of the first layer 21 away from the second layer 22, and are spaced apart from each other; the second energy storage units 102 are disposed on a side of the third layer 23 away from the second layer 22, and are spaced apart from each other.

Referring to FIG. 4, the positive tab 11 of each first energy storage unit 101 is electrically connected to the first sublayer 221 through a pad formed on a surface of the first sublayer 221 and exposed through an opening formed in the first layer 21. The negative tab 12 of each first energy storage unit 101 is electrically connected to the second sublayer 222 through a pad formed on a surface of the second sublayer 222 and exposed through an opening formed in the first layer 21. The positive tab 11 of each second energy storage unit 102 is electrically connected to the first sublayer 221 through a pad formed on a surface of the first sublayer 221 and exposed through an opening formed in the third layer 23, and the negative tab 12 of each second energy storage unit 102 is electrically connected to the second sublayer 222 through a pad formed on a surface of the second sublayer 222 and exposed through an opening formed in the third layer 23. In the present embodiment, two opposite sides of the connecting portion 2 are all provided with the energy storage units, which can further increase the capacity of the battery.

In some implementations, the plurality of first energy storage units 101 are parallel to each other and equally spaced apart from each other, i.e., the first energy storage units 101 are positioned at equal intervals, and the plurality of second energy storage units 102 are parallel to each other and equally spaced apart from each other, i.e., the second energy storage units 102 are positioned at equal intervals. Orthographic projections of the first energy storage units 101 on the first layer 21 coincide with orthographic projections of the second energy storage units 102 on the first layer 21. Capacities of the first energy storage units 101 may be equal or different, and volumes of the first energy storage units 101 may be equal or different. Capacities of the second energy storage units 102 may be equal or different, and volumes of the second energy storage units 102 may be equal or different. The capacities of each first energy storage unit 101 and each second energy storage unit 102 may be equal or different, and the volumes of each first energy storage unit 101 and each second energy storage unit 102 may be equal or different. With such arrangement, positions at the intervals between the energy storage units of the battery can achieve a same flexibility bending degree.

In some implementations, volume energy densities of the first energy storage units 101 are the same, and volumes of the first energy storage unit 101 are the same. Volume energy densities of the second energy storage units 102 are the same, and volumes of the second energy storage unit 102 are the same. The volume energy density of each first energy storage unit 101 is the same as that of each second energy storage unit 102, and the volume of each first energy storage unit 101 is the same as that of each second energy storage unit 102. The capacity C of the battery meets the following equation: C=N1ρS1h1+N2ρS2h2, where N1 is the number of the first energy storage units 101, N2 is the number of the second energy storage units 102, ρ is the volume capacity density of the first energy storage unit 101 and the second energy storage units 102, S1 is an area of an orthographic projection of the first energy storage unit 101 on the first layer 21; h1 is a height of the first energy storing unit 101 in a direction away from the first layer 21, S2 is an area of an orthographic projection of the second energy storage unit 102 on the third layer 23, and h2 is a height of the second energy storing unit 102 in a direction away from the third layer 23.

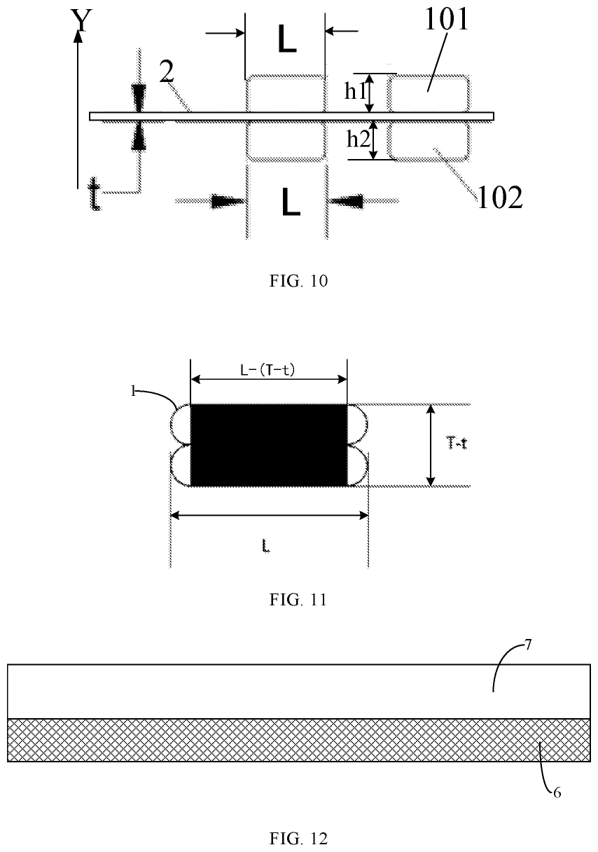

In some implementations, as shown in FIGS. 10 and 11, shapes of the orthographic projections of each first energy storage unit 101 and each second energy storage unit 102 on the first layer 21 are the same, and each are a rectangle plus four semicircles, the rectangle is located between the semicircles, and the four semicircles with a same diameter are located at two opposite ends of the rectangle, respectively, and are symmetrically arranged with respect to the rectangle. Areas of the orthographic projections of each first energy storage unit 101 and each second energy storage unit 102 on the first layer 21 are the same, and the height h1 of the first energy storage unit 101 in the direction away from the first layer 21 is the same as the height h2 of the second energy storage unit 102 in the direction away from the third layer 23. For the area of the orthographic projection of the first energy storage unit 101 or the second energy storage unit 102 on the first layer 21, a total area of the four semicircles is equal to ⅛π(T−t)²; an area of the rectangle is

$$[ L - \frac{( T - t )}{2} ] * ( T - t ) ,$$

an area of the orthographic projection of the first energy storage unit 101 or the second energy storage unit 102 on the first layer 21 is equal to

$$\frac{1}{8} {π ( T - t )}^{2} + [ L - \frac{( T - t )}{2} ] * ( T - t ) ,$$

the capacity of the first energy storage unit 101 or the second energy storage unit 102 is equal to

$$ρ \{ \frac{1}{8} {π ( T - t )}^{2} + [ L - \frac{( T - t )}{2} ] * ( T - t ) \} h 1 ,$$

then a capacity C1′ of a combination of energy storage units formed by one of the first energy storage units 101 and one of the second energy storage units 102, whose orthographic projections on the first layer 21 coincide, meets the following equation:

$$C {1}^{′} = ρ \{ \frac{1}{8} {π ( T - t )}^{2} + [ L - \frac{( T - t )}{2} ] * ( T - t ) \} ⋆ ( h 1 + h 2 ) .$$

Assuming that N1=N2=N, the capacity C′ of the battery meets the following equation:

$${C}^{′} = NC {1}^{′} = N ρ \{ \frac{1}{8} {π ( T - t )}^{2} + [ L - \frac{( T - t )}{2} ] * ( T - t ) \} ⋆ ( h 1 + h 2 ) .$$

Here, a direction perpendicular to the first layer 21 is referred to as a first direction Y. T is a total thickness of the battery in the first direction Y, t is a thickness of the connecting portion 2 in the first direction Y, h1 is a height of the first energy storing unit 101 in the first direction Y, h2 is a height of the second energy storage unit 102 in the first direction Y, L is a total length of a pattern of the orthographic projection of the first energy storage unit 101 or the second energy storage unit 102 on the first layer 21 in a direction in which the rectangular and the semicirculars are arranged.

Referring to FIG. 7, FIG. 8, FIG. 10 and FIG. 11, all positions with the same letters have the same dimension, comparing the capacity C1′ of a combination of energy storage units in the present embodiment with the capacity C1 of the energy storage unit in the above embodiment, when h=h1+h2, by comparison, it can be obtained that C1′−C1>0, and when N1=N2=N, by calculation, it can be obtained that C′−C>0. Therefore, the capacity of the battery in which the energy storage units are arranged on both sides of the connecting portion 2 is larger than the capacity of the battery in which the energy storage units are arranged on a single side of the connecting portion 2, so that a structure in which the energy storage units are arranged on both sides of the connecting portion 2 is preferable for the battery.

It should be noted that the energy storage units distributed on both sides of the connecting portion 2 may also be arranged in an array, as long as the positive tab and the negative tab of each energy storage unit can be connected to the first sublayer and the second sublayer, respectively. With such arrangement, more energy storage units can be integrated into the battery, and the capacity of the battery can be further increased.

Other structures of the battery in the present embodiment are the same as those in the above embodiments, and are not described herein again.

In the battery provided in the above-mentioned embodiment, the plurality of energy storage units are connected with each other in parallel through the connecting portion made of the flexible material, not only the capacity of the battery can be increased, but also the flexible bending of the battery can be realized, so that the battery can not only provide a power supply with a relatively large capacity for the flexible device, but also bend with the bending of the flexible device, so that the full flexibility of the flexible device can be realized.

An embodiment of the present disclosure further provides a display panel, as shown in FIG. 12, which includes the battery 6 in any one of the above embodiments, and further includes a flexible display module 7, where the battery 6 is disposed on a back side of the flexible display module 7, and the battery 6 is electrically connected with the flexible display module 7 for providing power to the flexible display module 7.

In the display panel adopting the battery in any one of the above-mentioned embodiments, not only a power supply with a relatively large capacity can be provided for the flexible display module, but also the battery can bend with the bending of the flexible device, so that the full flexibility of the flexible device can be realized well.

The display panel provided by the embodiment of the disclosure may be any product or component with a display function, for example, may be a flexible display device such as an OLED panel, an OLED television, a display, a mobile phone, a navigator and the like.

It will be understood that the above embodiments are merely exemplary embodiments employed to illustrate the principles of the present disclosure, and the present disclosure is not limited thereto. It will be apparent to those skilled in the art that various changes and modifications may be made therein without departing from the spirit and scope of the present disclosure, and these changes and modifications are to be considered within the scope of the disclosure.

1. A battery, comprising;
a plurality of energy storage units;
a connecting portion, which connects the plurality of energy storage units together in parallel;
wherein the connecting portion is made of a flexible material.

2. The battery of claim 1, wherein the connecting portion comprises a first layer, a second layer and a third layer which are sequentially stacked, the first layer and the third layer being made of a flexible insulating adhesive material, and the second layer being made of a metal material.

3. The battery of claim 2, wherein a total thickness of the first layer, the second layer and the third layer is in a range from 10 μm to 40 μm.

4. The battery of claim 2, wherein each energy storage unit comprises a positive plate, a diaphragm and a negative plate, which are sequentially stacked and wound to form a roll core, the positive plate extends out of a region, in which the positive plate, the diaphragm and the negative plate are sequentially stacked, to form a positive tab, and the negative plate extends out of the region, in which the positive plate, the diaphragm and the negative plate are sequentially stacked, to form a negative tab;
the second layer comprises a first sublayer and a second sublayer, and the first sublayer and the second sublayer are arranged in a same layer and are spaced apart from each other;
the positive tab is electrically connected with the first sublayer, and the negative tab is electrically connected with the second sublayer;
the first sublayer extends out of a region, in which the first layer, the second layer and the third layer are stacked, to form a positive pole of the battery, and the second sublayer extends out of the region, in which the first layer, the second layer and the third layer are stacked, to form a negative pole of the battery.

5. The battery of claim 4, wherein a material of the first sublayer comprises aluminum, and a material of the second sublayer comprises copper.

6. The battery of claim 4, wherein the plurality of energy storage units are disposed on a side of the first layer away from the second layer, the plurality of energy storage units being spaced apart from each other.

7. The battery of claim 6, wherein the plurality of energy storage units are parallel to and equally spaced apart from each other.

8. The battery of claim 4, wherein the plurality of energy storage units comprise a plurality of first energy storage units and a plurality of second energy storage units, the plurality of first energy storage units are arranged on a side of the first layer away from the second layer, and are spaced apart from each other;
the plurality of second energy storage units are arranged on a side of the third layer away from the second layer, and are spaced apart from each other.

9. The battery of claim 8, wherein the plurality of first energy storage units are parallel to and equally spaced apart from each other, and the plurality of second energy storage units are parallel to and equally spaced apart from each other;
orthographic projections of the first energy storage units on the first layer are coincident with orthographic projections of the second energy storage units on the first layer.

10. The battery of claims 1, further comprising: a packaging portion, which encases the plurality of energy storage units and the connecting portion.

11. The battery of claim 10, wherein the packaging portion comprises a heat sealing layer, a metal layer and a protective layer, which are sequentially stacked, the heat sealing layer being in contact with the plurality of energy storage units and the connecting portion.

12. The battery of claim 11, wherein a material of the heat sealing layer comprises a polypropylene (PP) material or cast polypropylene (CPP) material, a material of the metal layer comprises aluminum or stainless steel, and a material of the protective layer comprises nylon.

13. The battery of claim 11, wherein a total thickness of the heat sealing layer, the metal layer and the protective layer is in a range from 50 μm to 200 μm.

14. The battery of claim 6, wherein a shape of an orthographic projection of each energy storage unit on the first layer comprises any one of a rectangle, a rounded rectangle, an ellipse, a hexagon, or a rhombus.

15. The battery of claim 6, wherein volume energy densities of the energy storage units are the same, and volumes of the energy storage units are the same;
a capacity C of the battery meets following equation: C=NρSh, wherein N is the number of the energy storage units, ρ is the volume energy density of the energy storage unit, S is an area of the orthographic projection of the energy storage unit on the first layer; h is a height of the energy storage unit in a direction away from the first layer.

16. The battery of claim 8, wherein volume energy densities of the first energy storage units are the same, and volumes of the first energy storage units are the same, volume energy densities of the second energy storage units are the same, and volumes of the second energy storage units are the same;
the volume energy density of each first energy storage unit is the same as that of each second energy storage unit, and the volume of each first energy storage unit is the same as that of each second energy storage unit;
the capacity C of the battery meets an equation: C=N1ρS1h1+N2ρS2h2, wherein N1 is the number of the first energy storage units, N2 is the number of the second energy storage units, ρ is the volume capacity density of the first energy storage unit and the second energy storage unit, S1 is an area of the orthographic projection of the first energy storage unit on the first layer, h1 is a height of the first energy storage unit in a direction away from the first layer, S2 is an area of the orthographic projection of the second energy storage unit on the third layer, and h2 is a height of the second energy storage unit in a direction away from the third layer.

17. A display panel, comprising:
the battery of claim 1; and
a flexible display module, wherein
the battery is disposed on a back side of the flexible display module, and the battery is electrically connected to the flexible display module for providing power to the flexible display module.

18. The battery of claim 8, wherein a shape of an orthographic projection of each energy storage unit on the first layer comprises any one of a rectangle, a rounded rectangle, an ellipse, a hexagon, or a rhombus.

19. A display panel, comprising:
the battery of claim 2; and
a flexible display module, wherein
the battery is disposed on a back side of the flexible display module, and the battery is electrically connected to the flexible display module for providing power to the flexible display module.

20. A display panel, comprising:
the battery of claim 3; and
a flexible display module, wherein
the battery is disposed on a back side of the flexible display module, and the battery is electrically connected to the flexible display module for providing power to the flexible display module.
